(19) United States
(12) Patent Application Publication
(10) Pub. No.: US 2011/0208717 A1
(43) Pub. Date: Aug. 25, 2011

(54) CHAFFING SEARCH ENGINES TO OBSCURE USER ACTIVITY AND INTERESTS

(75) Inventor: Jeffrey S. Pierce, San Jose, CA (US)

(73) Assignee: INTERNATIONAL BUSINESS MACHINES CORPORATION, Armonk, NY (US)

(21) Appl. No.: 12/711,652

(22) Filed: Feb. 24, 2010

(51) Int. Cl. G06F 17/30

(52) U.S. Cl. 707/710; 707/722; 707/709; 707/E17.108; 707/E17.112

(57) ABSTRACT

A computer program product comprises a computer readable storage medium containing computer code that, when performed by a computer, implements a method for obscuring at least one computer search by a set of users from at least another user, wherein the method includes issuing a plurality of search requests comprised of one or more search requests issued by the set of users, and one or more spurious search requests, to at least one computer search provider; and separating search results received from the at least one computer search provider associated with the plurality of search requests into one or more intended search results in response to the one or more search requests issued by the set of users, and one or more spurious search results in response to the one or more spurious search requests not issued by the set of users.

### BACKGROUND

This invention relates generally to information searching technology, and more particularly to a method and system for chaffing search engines that obscures user activity and interests.

The vast amounts of information contained on the World Wide Web have established the Internet as a preeminent information and research tool. Several types of search engines have been created to assist in the retrieval of information from the Internet. A search engine is an information retrieval system designed to help find information stored on a computer system, such as on the Internet, inside a corporate or proprietary network (known as an Intranet), or in a personal computer. The search engine allows an individual to ask for content meeting specific criteria (typically those containing a given word or phrase) and retrieves a list of items that match those criteria. This list is often sorted with respect to some measure of relevance of the results. Search engines operate algorithmically, or are a combination of algorithmic and human input. Search engines use regularly updated indexes to operate quickly and efficiently. Some search engines also mine or gather data available in newsgroups, databases, or open directories.

Search engines generally employ Web crawlers (also known as Web spiders or Web robots/bots) that are programs or automated scripts, which browse networks such as the Internet in a methodical, automated manner as a means of providing up-to-date data. Web crawlers are mainly used to create a copy of all the visited pages for later processing by a search engine that will index the downloaded pages to provide fast searches. Crawlers may also be used for automating maintenance tasks on a Web site, such as checking links or validating hyper text markup language (HTML) code. Also, crawlers may be used to gather specific types of information from Web pages, such as harvesting e-mail addresses. A web crawler is one type of bot, or software agent. In general, a web crawler starts with a list of Uniform Resource Identifier/locators (URLs) to visit, called the seeds. As the web crawler visits these URLs, it identifies all the hyperlinks in the page and adds them to the list of URLs to visit, called the crawl frontier. URLs from the frontier are recursively visited according to a set of policies.

When a user enters a search phrase of keywords into a search engine there are two factors that determine which Web pages are returned in a list. One factor is the page rank, which is just a measure of goodness or frequency of page views, and has nothing to do with keywords, and the second factor is the weight associated with the keywords for the given page. The keyword weights are adjusted using factors such has how often a keyword appears on a page, the font used to display the keyword and even how close the keyword is to the top of the page. The search engine uses an equation, which involves both the weight of the keywords used in the query along with the page rank for a given page to compute a match score for that page. The web pages are then sorted by their match scores, and the results presented as the search results. One example equation to compute this match score could be:

Match Score=SUM(of matching keyword weights)×page rank.

### SUMMARY

In one aspect, a computer program product comprises a computer readable storage medium containing computer code that, when performed by a computer, implements a method for obscuring at least one computer search by a set of users from at least another user, wherein the method includes issuing a plurality of search requests comprised of one or more search requests issued by the set of users, and one or more spurious search requests, to at least one computer search provider; and separating search results received from the at least one computer search provider associated with the plurality of search requests into one or more intended search results in response to the one or more search requests issued by the set of users, and one or more spurious search results in response to the one or more spurious search requests not issued by the set of users.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a chaffing interface for a company or organization that obscures user activity and interests from one or more search engines according to embodiments of the invention.

FIG. 2 is a block diagram illustrating a chaffing interface for a plurality of companies or organizations that obscures user activity and interests from one or more search engines according to embodiments of the invention.

FIG. 3 is a flow chart of a method for implementing a chaffing interface for companies or organizations to obscure user activity and interests from one or more search engines according to embodiments of the invention.

FIG. 4 is a flow chart of a method for generating and refining chaff search terms for obscuring user activity and interests from one or more search engines according to embodiments of the invention.

FIG. 5 is a block diagram illustrating an exemplary system that may be utilized to implement exemplary embodiments of the invention.

The detailed description explains the preferred embodiments of the invention, together with advantages and features, by way of example with reference to the drawings.

### DETAILED DESCRIPTION

The Internet or Web has become a key source of information for research and competitive intelligence for organizations, businesses, and corporations. Internet search engines provided by major corporations are a convenient means for users who are members of organizations, businesses, and corporations to obtain information that they are seeking from the Internet. However, while the results of these Internet information searches may provide significant value to a company's users or an organization's members, the Internet-based information searches are potentially a source for competitor intelligence on what activities the companies or organizations are currently engaged in or are considering next. For example, a concentrated search in a specific area of technology, marketing, or product group, which employs an Internet search engine, may allow a search engine provider to predict the release of a new product from a company conducting the searches, before the product is officially announced. The Internet search provider may analyze web searches originating from the company's Internet protocol (IP) addresses, and by noting the increasing prevalence of searches with respect to the specific area of technology or product group, form a prediction about the company's upcoming technology or product plans.

Presently there are four solutions for handling the vulnerability that companies and organizations experience with respect to competitive loss of information with the use of Internet search engines: 1) block access to search engines from a company or organization's IP addresses, which is impractical and counter-productive; 2) spread Internet searches across multiple search engines, which is problematic because the quality of search engines vary, and because there are an insufficient number of search engines for effectively dividing up search traffic to obscure a company's activities; 3) employ an anonymizer to hide the source (IP address) of a particular search, which shifts the burden of trust from the search provider to the anonymizer rather than addressing the underlying issue, although a company providing anonymizing services arguably does have more incentive not to violate the trust of its users, and additionally, the anonymizer may also have trouble scaling to address the needs of many companies; 4) do nothing and trust search engine providers not to use the information they gather, which requires the assumption of a certain level of benevolence on the part of search engine providers that may not be warranted.

Embodiments of the invention provide a method and system for obscuring a company's or organization's (herein referred to as a group) interests by hiding the directed or concentrated searches of a company's users or organization's members in a larger number of searches that the company or organization has no interest in. The generation of a large number of spurious or “fake” (herein referred to as “chaff”) searches acts to mislead a search provider, who would ideally have no way to separate the real from the chaff searches, and would thus be unable to infer the group's intentions. Alternately, rather than focusing on preventing a search provider from inferring a group's intentions, the fake (chaff) searches may instead focus on giving a search provider an incorrect view of the group's intentions, by concentrating searches on alternate areas that are not of interest to the company or organization (e.g., by trying to convince the search provider that the company was going to launch a product X when in fact the company was focusing on product Y).

Embodiments of the invention issue search requests to one or more search providers, and separate incoming search results into real (issued in response to actual search requests by a group's users or members) and spurious (chaff) results. Embodiments of the invention issue search requests in a manner that the search requests appear to be real (so that search engine providers may not easily determine which requests are real and which search requests are chaff), while also choosing requests that serve to obscure the group's interests.

Embodiments of the invention mimic the traffic patterns of actual search requestors. Actual search requestors do not just issue independent requests at random; actual searchers also often follows up their initial search requests with additional requests refining the search, e.g., by trying variants of their search terms, or following an alternate search thread based on associations that arose in the initial search. Actual search requestors also occasionally ask for versions of pages cached by the search engine provider. Embodiments of the invention incorporate models of searching behavior that are developed by capturing and analyzing actual searching behavior, thereby mimicking the search traffic patterns created by real users. Embodiments of the invention may continue to improve the search behavioral model over time, thereby increasing the difficulty for search engines to build or ascertain a predictive model to overcome the deceptive searching patterns generated by embodiments of the invention.

Embodiments of the invention generate search terms that are plausible (i.e., logically related to a group's business or interests) and serve to either prevent the consulted search engine from inferring the company's true interests, or conversely mislead the search engine into inferring interests that the company does not actually hold. For example, embodiments of the invention utilize a source (or sources) of chaff search terms that are plausible for the company the invention is protecting (e.g., searches for celebrities would not be particularly effective for obscuring a computer company's interests). The chaff search terms may be provided directly by the company interested in conducting the search, or the chaff search terms may be from a set of sources (e.g., public websites) identified by the company, or the chaff search terms may be drawn from a set of sources identified by the company that are narrowed by providing sample terms or by explicit choice. Alternately, embodiments of the invention may be provided as a service for multiple companies, with the service provider reusing actual searches as chaff searches for other companies, thereby blending all of the searches for the protected companies to prevent a given search engine from identifying the particular interests of any individual company.

In addition to providing individual search terms, the chaff sources employed by embodiments of the invention would also need to provide (or allow the invention to infer) likely paths for an initial search to evolve. For example, a website announcing the release of version 2 of ‘Ruby on Rails’ may lead to the following chaff search chain: “rails”, “ruby rails”, “rails version 2”, “gem install”. Embodiments of the invention may determine these search chains through human intervention (e.g., a human could select sections of a chaff source that would make useful chains), through simple heuristics (e.g., looking for words and phrases that recur across multiple chaff sources), or by applying more advanced concept discovery techniques from the artificial intelligence community. Embodiments of the invention may also generate search chains in an iterative manner by issuing a search, visiting the top 2-3 results returned by the search engine, and performing additional searches with search chains based on the content retrieved from the returned Web sites.

Embodiments of the invention also address the fact that a search engine may potentially be able to separate real searches from chaff searches by looking at the cookies attached to the searches. For example, users who log into search engine accounts may potentially tip off the search engines with which searches are real. Embodiments of the invention would therefore also allow (a) stripping off the cookies attached to all outgoing searches or (b) attaching cookies belonging to a group's users or members to the chaff searches.

Embodiments of the invention may take several possible forms, including: a software application that runs on hardware provided by a group operating the software; an appliance (both hardware and software) sold as a unit; and a service provided by a third party that generates and issues chaff requests on behalf of one or more groups that conduct Internet searches.

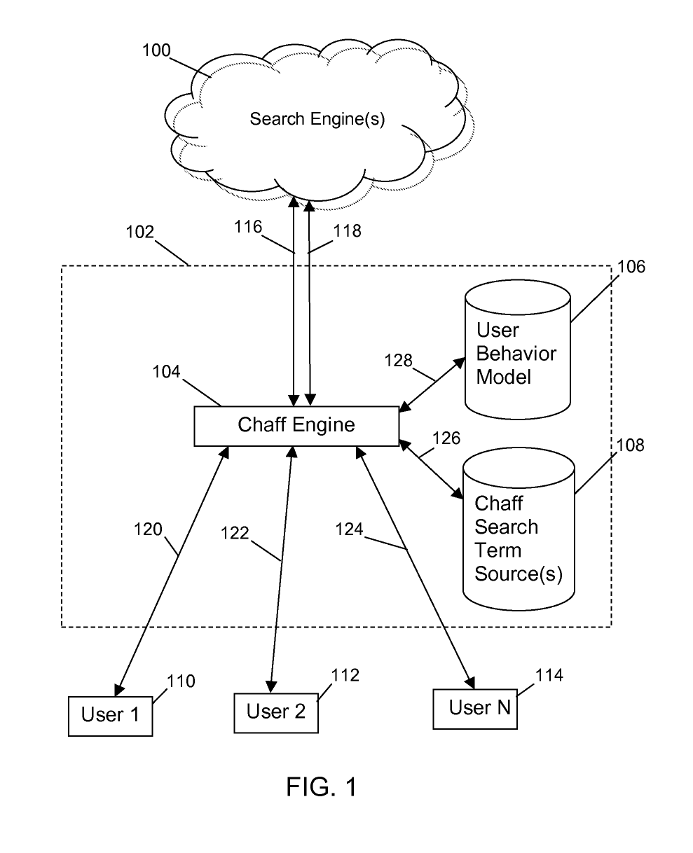

FIG. 1 is a block diagram illustrating a chaffing interface 102 for a company or organization that obscures one or more user's (110, 112, 114) activities and interests from one or more search engines 100 according to embodiments of the invention. The chaffing interface 102 has a chaff engine 104, which generates chaff (spurious) search requests and receives chaff (non-intended) search results as symbolized by the bidirectional arrow 116 to one or more search engines 100, as well as accepting real intended search requests from one or more users (110, 112, 114) as symbolized via bidirectional arrows (120, 122, 124), and forwarding the real intended search requests as symbolized by bidirectional arrow 118 to the one or more search engines 100. The intended search results from the one or more search engines 100 are returned to the one or more users (110, 112, 114) via the symbolic bidirectional lines (118, 120, 122, 124) via the chaff engine 104. The chaff engine 104 obtains chaff search terms from one or more chaff search term sources 108 that are plausible to the one or more users (110, 112, 114) in a group via symbolic bidirectional arrow 126. In addition, the chaff engine 104 utilizes a user behavior model 106 to mimic the traffic patterns of actual searchers via symbolic bidirectional arrow 128.

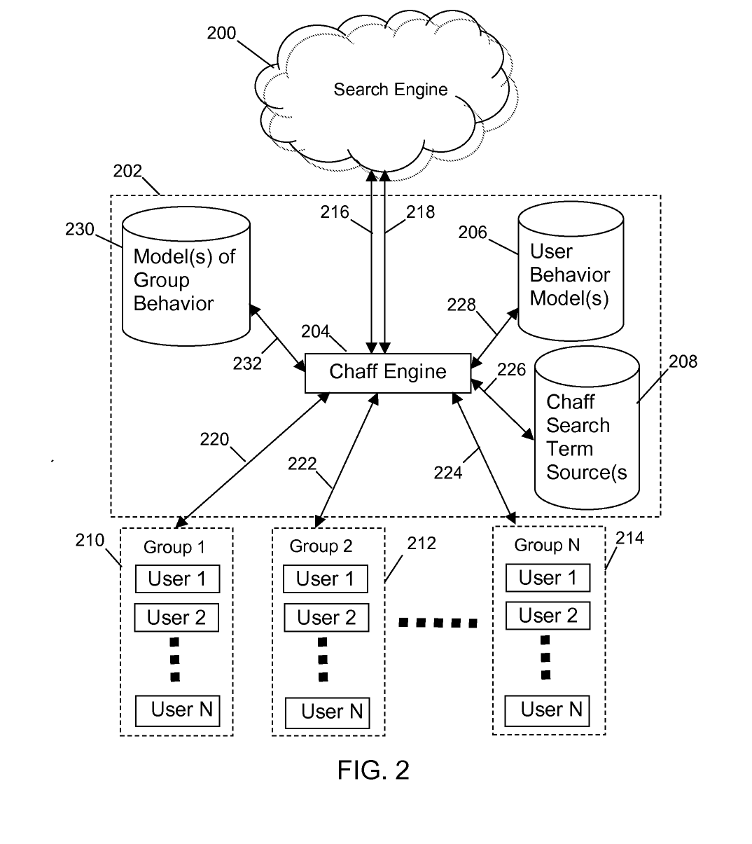

FIG. 2 is a block diagram illustrating a chaffing interface 202 for a plurality of groups (companies, organizations, etc.) (210, 212, 214) that obscures user activity and interests from one or more search engines 200 according to embodiments of the invention. The chaffing interface 202 has a chaff engine 204, which generates chaff (spurious) search requests and receives chaff (non-intended) search results as symbolized by the bidirectional arrow 216 to one or more search engines 200, as well as accepting real intended search requests from one or more groups of users (210, 212, 214) as symbolized via bidirectional arrows (220, 222, 224), and forwarding the real intended search requests as symbolized by bidirectional arrow 218 to the one or more search engines 200. The intended search results from the one or more search engines 200 are returned to the one or more groups (210, 212, 214) via the symbolic bidirectional lines (218, 220, 222, 224) via the chaff engine 204. The chaff engine 204 obtains chaff search terms from one or more chaff search term sources 208 that are plausible to the one or more groups (210, 212, 214) in a group via symbolic bidirectional arrow 226. In addition, the chaff engine 204 utilizes a user behavior model 206 to mimic the traffic patterns of actual searchers via symbolic bidirectional arrow 228, and models of group behavior 230 to mimic organizational search behaviors via symbolic bidirectional arrow 232.

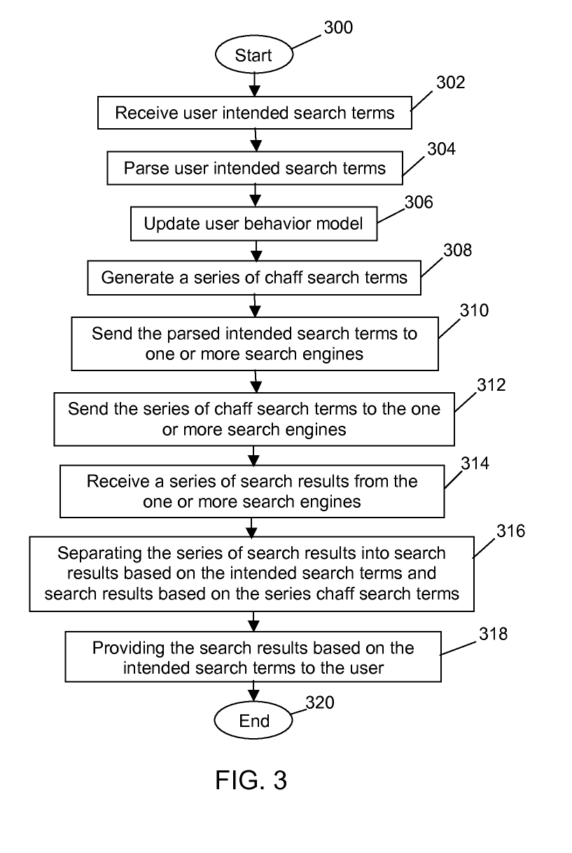

FIG. 3 is a flow chart of a method for implementing a chaffing interface for companies or organizations to obscure user activity and interests from one or more search engines according to embodiments of the invention. The process starts (block 300) by receiving user intended search terms (block 302) at the chaff engine, and the chaff engine parsing the user intended search terms (block 304). Subsequently, the chaff engine updates a user model (block 306), and generates a series of chaff search terms (block 308). The chaff engine sends the parsed intended search terms (block 310) and the series of chaff search terms (block 312) to one or more search engines. Subsequently, the chaff engine receives a series of search results from the one or more search engines (block 314), and the chaff engine separates the series of search results into search results based on the intended search terms and search results based on the series chaff search terms (block 316). The chaff engine provides the search results based on the intended search terms to the user (block 318), and the process concludes (block 320).

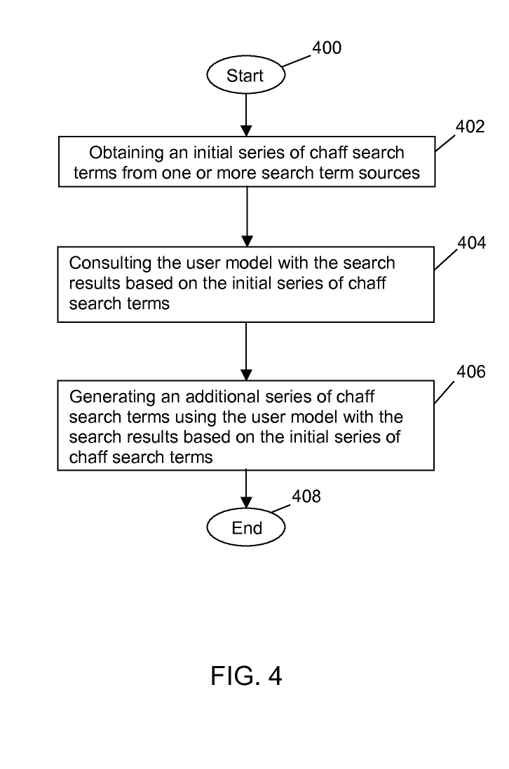

FIG. 4 is a flow chart of a method for generating and refining chaff search terms for obscuring user activity and interests from one or more search engines according to embodiments of the invention. The process starts (block 400) with the chaff engine obtaining an initial series of chaff search terms from one or more search term sources (block 402), and consulting a user model with search results based on the initial series of chaff search terms (block 404), and generating an additional series of chaff search terms using the user model with the search results based on the initial series of chaff search terms (block 406), and the process concludes (block 408).

For simplicity of illustration, real and chaff searches are blended in FIGS. 3 and 4, however this should not imply that the chaff engine only generates chaff searches once a user has initiated a real search. In fact, the chaff engine may generate chaff searches independently of the ongoing real searches initiated by users. In other words, a new real search doesn't automatically initiate a new chaff search, although the chaff engine will use the terms and timing to improve its model of user terms and behaviors in order to generate better chaff searches in the future. Furthermore, the chaff engine doesn't always generate follow-up searches. Follow-on chaff searches are probabilistic. When the chaff engine receives chaff search results back (for any arbitrary chaff search request), the chaff engine has some probability of initiating a follow-up chaff search that draws on the user behavior model and the chaff source model. For the results of that search, the chaff engine again has some probability of initiating a follow-on chaff search, etc.

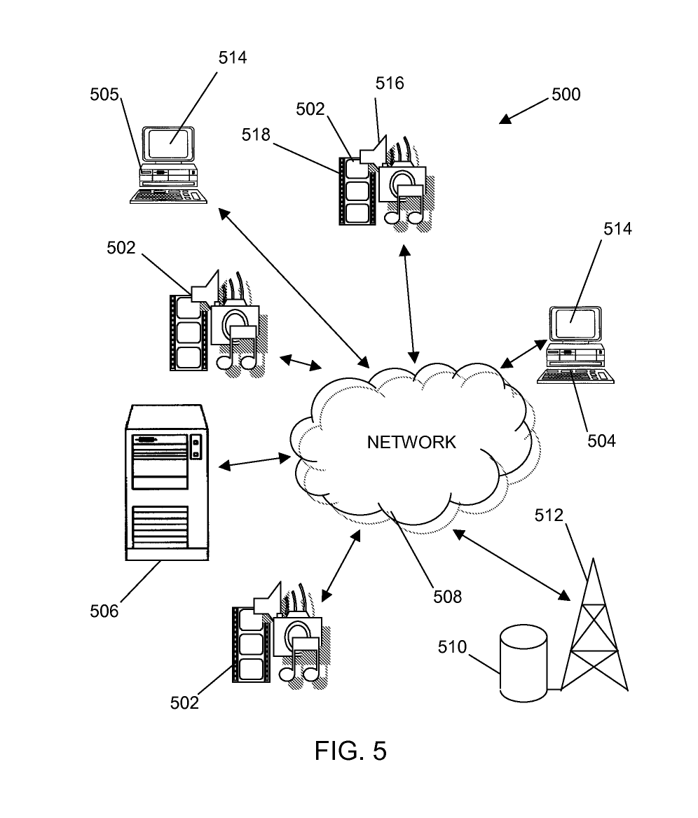

FIG. 5 is a block diagram illustrating an exemplary system that may be utilized to implement exemplary embodiments of the invention. The system 500 includes remote devices in the form of client devices including one or more multimedia/communication devices 502 equipped with speakers 516 for implementing audio, as well as display capabilities 518 for facilitating graphical user interface (GUI) aspects of the present invention, including the display for configuration of search terms and parameters. In addition, client devices include mobile computing devices 504 and desktop computing devices 505 equipped with displays 514 for use with the GUI of the present invention are also illustrated. The remote devices 502 and 504 may be wirelessly connected to a network 508. The network 508 may be any type of known network including a local area network (LAN), wide area network (WAN), global network (e.g., Internet), intranet, etc. with data/Internet capabilities as represented by server 506. Communication aspects of the network are represented by cellular base station 510 and antenna 512. Each remote device 502 and 504 may be implemented using a general-purpose computer running computer programs. The chaffing search software may be resident on a storage medium local to the remote devices 502 and 504, or maybe stored on the server system 506 or cellular base station 510. The server system 506 may belong to a public service. The remote devices 502 and 504 and desktop device 505 may be coupled to the server system 506 through multiple networks (e.g., intranet and Internet) so that not all remote devices 502, 504, and desktop device 505 are coupled to the server system 506 via the same network. The remote devices 502, 504, desktop device 505, and the server system 506 may be connected to the network 508 in a wireless fashion, and network 508 may be a wireless network. In a preferred embodiment, the network 508 is a LAN and each remote device 502, 504 and desktop device 505 implements a user interface application (e.g., web browser) to contact the server system 506 through the network 508. Alternatively, the remote devices 502 and 504 may be implemented using a device programmed primarily for accessing network 508 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions performable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1. A computer program product comprising a computer readable storage medium containing computer code that, when performed by a computer, implements a method for obscuring at least one computer search by a set of users from at least another user, wherein the method comprises:
issuing a plurality of search requests comprised of one or more search requests issued by the set of users, and one or more spurious search requests, to at least one computer search provider; and
separating search results received from the at least one computer search provider associated with the plurality of search requests into one or more intended search results in response to the one or more search requests issued by the set of users, and one or more spurious search results in response to the one or more spurious search requests not issued by the set of users.

2. The computer program product according to claim 1, wherein the issuing comprises mimicking at least one traffic pattern of at least one searcher among the set of users for the one or more spurious search requests.

3. The computer program product according to claim 2, wherein the mimicking comprises:
capturing the traffic pattern of the searcher; and
analyzing the traffic pattern.

4. The computer program product according to claim 1, wherein the issuing comprises sending one or more search terms to the at least one computer search provider that are plausible with respect to the set of users; and
wherein the one or more plausible search terms are logically related to an interest of the set of users, and are configured to prevent the at least one computer search provider from determining the interest.

5. The computer program product according to claim 1, wherein issuing comprises sending one or more search terms to the at least one computer search provider that are plausible with respect to the set of users; and
wherein the one or more plausible search terms are logically related to an interest of the set of users, and are configured to mislead the at least one computer search provider into inferring a false interest that is not the interest of the set of users.

6. The computer program product according to claim 1, wherein at least one of the one or more spurious search requests was previously issued by a one of a second set of users.

7. The computer program product according to claim 1, further comprising removing a cookie identifying a user of the set of users from the one or more search requests issued by the set of users.

8. The computer program product according to claim 1, further comprising attaching a cookie identifying a user of the set of users to the one or more spurious search requests.

9. A method for obscuring user activity and interests from one or more search engines, the method comprising:
receiving user intended search terms by a chaff engine;
parsing the user intended search terms by the chaff engine;
updating a user search behavior model by the chaff engine;
generating a series of chaff search terms by the chaff engine based on the user search behavior model;
sending the parsed intended search terms and the series of chaff search terms to one or more search engines by the chaff engine;

10. The method of claim 9, further comprising:
receiving a series of search results from the one or more search engines by the chaff engine;
separating the series of search results into search results based on the intended search terms and search results based on the series chaff search terms by the chaff engine; and
providing by the chaff engine the search results based on the intended search terms to the user.

11. The method of claim 9, wherein the generating the series of chaff search terms comprises:
obtaining an initial series of chaff search terms from one or more search term sources;
consulting the user search behavior model with search results based on the initial series of chaff search terms; and
generating an additional series of chaff search terms based on the user search behavior model with the search results based on the initial series of chaff search terms.

12. The method of claim 11, wherein generating the series of chaff search terms further comprises generating an additional series of chaff search terms based on a content of a website contained in the search results based on the initial series of chaff search terms.

13. The method of claim 9, further comprising removing a cookie identifying a user from the parsed intended search terms.

14. The method of claim 9, further comprising attaching a cookie identifying a user to the series of chaff search terms.

15. A computer program product comprising a computer readable storage medium containing computer code that, when performed by a computer, implements a method for obscuring user activity and interests from one or more search engines, wherein the method comprises
receiving user intended search terms;
parsing the user intended search terms;
updating a user search behavior model;
generating a series of chaff search terms based on the user search behavior model;
sending the parsed intended search terms and the series of chaff search terms to one or more search engines;

16. The computer program product according to claim 15, further comprising:
receiving a series of search results from the one or more search engines;
separating the series of search results into search results based on the intended search terms and search results based on the series chaff search terms; and
providing the search results based on the intended search terms to the user.

17. The computer program product according to claim 15, wherein the generating the series of chaff search terms comprises:
obtaining an initial series of chaff search terms from one or more search term sources;
consulting the user search behavior model with search results based on the initial series of chaff search terms; and
generating an additional series of chaff search terms based on the user search behavior model with the search results based on the initial series of chaff search terms.

18. The computer program product according to claim 17, wherein generating the series of chaff search terms further comprises generating an additional series of chaff search terms based on a content of a website contained in the search results based on the initial series of chaff search terms.

19. The computer program product according to claim 15, further comprising removing a cookie identifying a user from the parsed intended search terms.

20. The computer program product according to claim 15, further comprising attaching a cookie identifying a user to the series of chaff search terms.
